(19) United States
(12) Patent Application Publication
(10) Pub. No.: US 2006/0018271 A1
(43) Pub. Date: Jan. 26, 2006

(54) Distributed network address management method and apparatus

(75) Inventors: Arun C. Alex, Bartlett, IL (US); Kunnath Sudhir, Bolingbrook, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 10/894,748

(22) Filed: Jul. 20, 2004

(51) Int. Cl. H04Q 7/00

(52) U.S. Cl. 370/328

(57) ABSTRACT

Various nodes within a communication network each have information regarding the network address that are locally supported and information regarding which network addresses (or blocks of network addresses) are supported by specified remote non-central nodes. Network address information as provided by mobile nodes when seeking to initiate a communication are then compared against such information to determine whether to locally support the communication or to automatically forward the corresponding request to a remote node to support the communication.

### TECHNICAL FIELD

This invention relates generally to network communications and more particularly to the management of network addresses.

### BACKGROUND

Many communication networks are characterized by the use of network addresses to identify individual network entities and to particularly differentiate one user platform (or user) from another. Such addressing schemes facilitate the appropriate routing of communications to a particular intended target recipient. In general, the use of network addresses in this fashion works well presuming the availability of a sufficient pool of unique addresses.

With increasing regularity, however, many networks are supporting mobile user platforms. Wireless access points often serve to provide a point of contact for such mobile platforms. In the absence of a genuine central point of management of control, such access points typically couple to and operate in conjunction with a distributed base of address-management entities.

Given this architecture, ambiguity and confusion results from time to time as mobile platforms move from one access point to another. Such movement often results in a loss of connectivity with the network (due either to network imperfections or the unilateral actions of the mobile user). Not infrequently, a unique network address as may be associated with a given mobile platform will become associated with more than a single address management entity. When this occurs, multiple nodes in a shared network will advertise the same network address (or set of addresses) on that network. It then becomes difficult to identify the correct route to be used to forward a given communication to such a user platform. In such instances, the communication may be misdirected and ultimately fail to reach the intended recipient.

Prior suggestions to ameliorate this circumstance typically depend upon the deployment and use of a single node to arbitrate such a conflict. Such an architectural approach bears its own burdens, however. As one example, this approach presents an opportunity for a single point of failure for the network. As another example, this approach also presents scalability issues. In particular, a single-node approach may restrict design freedom to expand the size or services supported by a given network.

### BRIEF DESCRIPTION OF THE DRAWINGS

The above needs are at least partially met through provision of the network address management method and apparatus described in the following detailed description, particularly when studied in conjunction with the drawings, wherein:

FIG. 1 a block diagram as configured in accordance with various embodiments of the invention;

FIG. 2 a flow diagram as configured in accordance with various embodiments of the invention; and

FIG. 3 a flow diagram as configured in accordance with various embodiments of the invention.

Skilled artisans will appreciate that elements in the figures are illustrated for simplicity and clarity and have not necessarily been drawn to scale. Also, common but well-understood elements that are useful or necessary in a commercially feasible embodiment are often not depicted in order to facilitate a less obstructed view of these various embodiments of the present invention. It will also be understand that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a distributed approach to network address duplication avoidance serves to substantially resolve the identified problem while also tending to avoid the problems associated with a single-node solution.

To facilitate network communications, a communication that includes a specific network address as corresponds to a given mobile node is received from that mobile node. Upon determining that this specific network address is not locally supported, a remote non-central node that does support the specific network address is automatically notified to facilitate a subsequent communication from the mobile node by the remote non-central node.

In one embodiment, the specific network address comprises a specific Internet Protocol address. Pursuant to a preferred approach, the determination regarding non-support of the specific network address comprises determining that the specific network address does not comprise a part of a block of network addresses as are assigned for local use.

To facilitate this approach, and pursuant to a preferred embodiment, the remote non-central node will source communications (such as multicast communications) from time to time that identify one or more network addresses that are presently supported by the remote non-central node. Local nodes can then store such information for subsequent use as indicated above.

Though various configurations can be employed to embody these teachings, in general, this approach tends to significantly avoid the problems that are usually associated with network address duplication while also substantially avoiding the issues that are associated with the use of centralized single-node solutions.

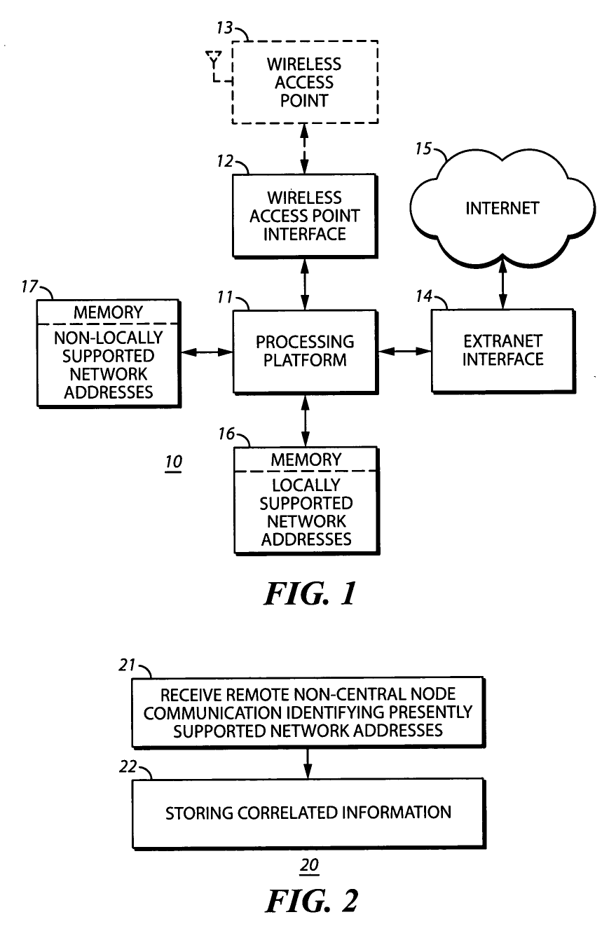

Referring now to FIG. 1, an apparatus 14 suitably configured to support these embodiments comprises generally a processing platform 11. In a preferred embodiment this processing platform 11 comprises a fully or partially programmable platform. If desired a hard-wired or dedicated-purpose platform of choice can be employed as well. This processing platform 11 can comprise a sole-purpose mechanism or can share functionality with other capabilities. A variety of known network elements will readily suffice to serve as the processing platform, including but not limited to home agents, packet data serving nodes (PDSN's), gateway general packet radio service support nodes (GGSN's), authentication, authorization, and accounting servers (AAA's), foreign agent control nodes, and serving general packet radio service support nodes, to name a few. Those skilled in the art will recognize that such elements are typically at least partially programmable and can be readily configured to accord with these teachings. It will also be understood that the functionality described below can be distributed over a plurality of processing platforms to thereby together effect a virtual processing platform 11. All of these architectural options and configuration choices are generally well understood in the art and hence additional explanatory material need not be provided here for the sake of brevity and the preservation of focus.

Pursuant to a preferred approach, the processing platform 11 operably couples to a wireless access point interface 12. The latter element is well understood in the art and typically serves to provide an interface for one or more wireless access points 13. The particular wireless technology and protocols employed and supported by the wireless access point 13 are not particularly important to these embodiments and hence are not described in greater detail. It will be understood that these embodiments are essentially compatible with all such wireless technologies, including those that are presently known and those that are hereafter developed.

This apparatus 10 also comprises an extranet interface 14 that operably couples to the processing platform 11. This extranet interface 14 serves to provide access to one or more extranets such as, for example, the Internet 15. Again, such extranet interfaces are well known in the art and require no further elaboration here.

In a preferred embodiment, the processing platform 11 has at least a first mode and a second mode of operation. Pursuant to the first mode of operation the processing platform 11 supports direct facilitation of an extranet communication by a wireless node that utilizes the wireless access point 13 using one of a group of locally supported network addresses. Pursuant to the second mode of operation the processing platform 11 supports automatic forwarding of a communication request from a wireless node that uses a non-locally supported network address to a non-local node that does support the non-locally supported network address.

To support these modes of operation, in a preferred embodiment, the processing platform 11 also operably couples to a first memory 16 having locally-supported network addresses stored therein (wherein some of these locally supported addresses may be presently assigned to corresponding wireless nodes and where at least some of the locally-supported network address may be presently unassigned to any corresponding wireless nodes) and also to a second memory 17 having non-locally supported network addresses stored therein. In a preferred embodiment, this second memory 17 will also have information stored therein that correlates these non-locally supported network addresses with the non-local nodes that do support them. These memories 16 and 17 can be separate physical entities (as suggested by the illustration) or can comprise a single memory platform. It will also be understood that these memories can be separate physical entities with respect to the processing platform 11 or can be integrated therewith. It will also be understood that these memories can be integrated and or distributed over or with other elements as may best suit the needs of a given application.

So configured, the processing platform 11 can determine when a communication request as sourced by a wireless node is using a locally supported network address and when it is not. This, in turn, permits additional processing as described below to effect successful facilitation of the wireless node's communication without fostering duplication and regardless of whether the network address proffered by the wireless node is locally supported.

Referring now to FIG. 2, in some of the embodiments described with respect to FIG. 1, a memory (17) has non-locally supported network addresses stored therein. Such information can be gleaned in the first instance in a variety of ways. Pursuant to a preferred approach 20, the apparatus 10 receives 21 a communication from a remotely located non-central node that identifies at least one network address that is presently supported by the remote non-central node. As used herein, “non-central” will be understood to indicate a network element that does not track or manage, in a centralized fashion, the network resource(s) of interest. In particular, in this example, the non-central remote node does not track or manage, in a centralized fashion, all network addresses for the entire network. Instead, this remote node tracks and manages only some of the network addresses allocated to and by this network (operating in this regard much like the apparatus 10 itself).

The communication from the remotely located non-central node can occur in a variety of ways. These communications can include, for example, point-to-point messages that expressly target the apparatus 10. In a preferred embodiment, however, such communications will typically comprise a multicast communication or broadcast that reaches, with a single transmission, a potentially large number of receptive endpoints. Such transmissions can be as irregular or as periodic as may be appropriate to the needs of a given application. It will also be understood that such communications can be temporally or event driven (or both) again as best suits the needs of a given deployment.

The apparatus 10 then stores 22 at least some information that correlates the remote-non-central node with the information regarding the network addresses that are presently supported by the remote non-central node. This, in turn, permits the apparatus 10 to not only have the wherewithal to identify a particular network address as being one that is supported by a remote node but to also be able to identify that particular remote node.

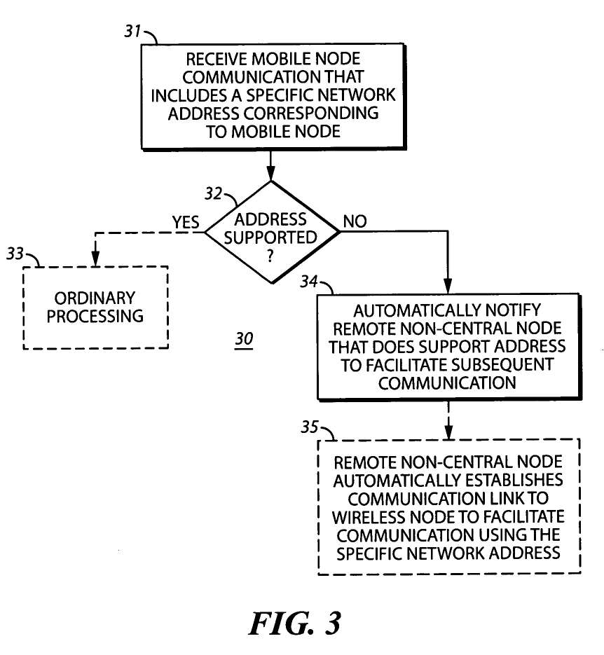

Referring now to FIG. 3, a process 30 to make use of such information, however received, and to thereby facilitate a network communication will be presented.

Upon receiving 31 from a mobile node a communication that includes a specific network address as corresponds to that mobile node (such as, for example, an Internet Protocol address as has been previously allocated to that mobile node), the process 30 determines 32 whether that network address is locally supported. Such a determination 32 can be facilitated, for example, by determining that the specific network address does not comprise a part of a block of network addresses (such as Internet Protocol addresses) as are presently assigned for local use. When the specific network address is locally supported, ordinary local processing 33 of that and subsequent communications with respect to that mobile node ensues in accord with well understood prior practice.

Upon determining, however, that no local support for the specific network address exists, the process 30 provides for automatic notification 34 of a remote non-central node that does support the specific network address. To facilitate this activity, the process 30 can effect accessing a local (or remotely accessible) store of information that contains information regarding the specific network address and the remote non-central node that provides support for that specific network address. This notification can take any suitable form and will preferably serve to provide sufficient information to the remote non-central node to permit the latter to facilitate the mobile node communication.

In a preferred embodiment the remote non-central node will then automatically establish 35 a communication link to the wireless node to facilitate a communication from the wireless node using the specific network address.

These teachings can be employed in various ways to suit a given situation. In a preferred approach, all Internet Protocol address pools are divided into relatively small fixed size blocks (with the size preferably being a power of two). One node in a given cluster will mange the Internet Protocol address blocks (though this functionality can be statically assigned or dynamically elected or assigned as may best accommodate the needs of a given set of design requirements). Each such node will then own one or more Internet Protocol address blocks as necessary pursuant to one approach, any such node may request allocation of a free block of Internet Protocol address. Furthermore, if desired, an Internet Protocol address block lacking an active Internet Protocol address can be released (automatically or upon request or instruction). Using techniques such as multicasting these nodes then broadcast or advertise their respective Internet Protocol address block assignments so that other respective nodes can receive and use such information in a manner consistent with these teachings. By organizing such addresses on a block basis, network communication resource needs necessary to support the distribution of knowledge regarding which addresses are supported by which nodes are significantly reduced as compared to providing such information on an address-by-address basis (though the latter approach can be used if desired).

As one illustrative example, consider a home agent that provides access with respect to a block of locally supported Internet Protocol addresses. Upon receiving an Internet Protocol communication request as corresponds to a wireless node, this home agent can ascertain whether that wireless node poses a locally supported Internet Protocol address. When true, the home agent directly facilitates that communication request. When not true, the home agent automatically provides information regarding the communication request to a non-central remote node that is known (for example, by accessing an Internet Protocol map that correlates Internet Protocol addresses with specific supporting nodes) to the home agent to support the Internet Protocol address in question. The non-central remote node can then itself directly facilitate the communication request. It will be well appreciated that other network elements besides a home agent can operate in a similar fashion to facilitate this same basic process.

As a more specific illustrative example, a mobile node can establish a wireless traffic channel with a wireless access point. The latter in turn then notifies a packet control function (PCF) in accord will ordinary practice. The PCF then selects a known packet data serving node (PDSN) and establishes an RP channel to PDSN (where “RP” refers to an RNN to PDSN protocol). The mobile node then establishes a point-to-point protocol (PPP) session with the PDSN and transmits a registration request that includes its Internet Protocol address. The PDSN then contacts a corresponding authentication, authorization, and accounting (AAA) element to identify the home agent to which the registration request should be forwarded. The PDSN then forwards the registration request to that home agent. The latter then determines whether the specific Internet Protocol address is locally supported in accord with the above description and arranges local or remote support as appropriate.

So configured, network address duplication can be substantially avoided while also avoiding the need for a central point of address management and tracking.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, these same teachings can be employed in a situation where a mobile node does not present any network address as corresponds to itself. In such an instance, a remote non-central node having one or more network addresses (i.e., a pool of network addresses) that are available for assignment to such mobile nodes can be automatically notified as is otherwise set forth above in order to permit the latter to facilitate subsequent communications from the mobile node.

We claim:

1. A method of facilitating a network communication, comprising:
receiving from a mobile node a communication;
determining that the mobile node did not provide in the communication a locally supported specific network address and automatically notifying a remote non-central node to facilitate a subsequent communication from the mobile node.

2. The method of claim 1 wherein receiving from a mobile node a communication further comprises receiving from a mobile node a communication that does not include a network address as corresponds to the mobile node.

3. The method of claim 2 wherein automatically notifying a remote non-central node to facilitate a subsequent communication from the mobile unit further comprises notifying a remote non-central node that has access to a pool of network addresses that are available for assignment to mobile nodes that do not present a network address.

4. The method of claim 1 wherein receiving from a mobile node a communication further comprises receiving from a mobile node a communication that includes a specific network address as corresponds to the mobile node.

5. The method of claim 4 wherein determining that the mobile node did not provide in the communication a locally supported specific network address further comprises determining that the specific network address is not locally supported.

6. The method of claim 5 wherein receiving from a mobile node a communication that includes a specific network address as corresponds to the mobile node further comprises receiving from a mobile node a communication that includes a specific Internet Protocol address as corresponds to the mobile node.

7. The method of claim 5 wherein receiving from a mobile node a communication that includes a specific network address as corresponds to the mobile node further comprises receiving the communication at at least any of:
a home agent;
a packet data serving node;
a gateway general packet radio service support node;
an authentication, authorization, and accounting server;
a foreign agent control node;
a serving general packet radio service support node.

8. The method of claim 5 wherein determining that the specific network address is not locally supported further comprises determining that the specific network address does not comprise a part of a block of network addresses as are presently assigned for local use.

9. The method of claim 8 wherein determining that the specific network address does not comprise a part of a block of network addresses as are presently assigned for local use further comprises determining that the specific network address does not comprise a part of a block of Internet Protocol addresses as are presently assigned for local use.

10. The method of claim 9 wherein determining that the specific network address does not comprise a part of a block of Internet Protocol addresses as are presently assigned for local use further comprises making the determination that the specific network address does not comprise a part of a block of Internet Protocol addresses as are presently assigned for local use at at least one of:
a home agent;
a packet data serving node;
a gateway general packet radio service support node;
an authentication, authorization, and accounting server;
a foreign agent control node;
a serving general packet radio service support node.

11. The method of claim 5 wherein automatically notifying a remote non-central node that does support the specific network address further comprises automatically identifying the remote non-central node.

12. The method of claim 11 wherein automatically identifying the remote non-central node further comprises automatically accessing locally stored information regarding network address assignments of at least one remote node.

13. The method of claim 12 wherein automatically accessing locally stored information regarding network address assignments of at least one remote node further comprises automatically accessing locally stored information regarding Internet Protocol address assignments of at least one remote node.

14. The method of claim 5 and further comprising:
the remote non-central node automatically establishing a communication link to the wireless node to facilitate a communication from the wireless node using the specific network address.

15. The method of claim 5 and further comprising:
receiving a communication from the remote non-central node identifying at least one network address that is presently supported by the remote non-central node.

16. The method of claim 15 wherein receiving a communication from the remote non-central node further comprises receiving a multicast communication from the remote non-central node.

17. The method of claim 15 and further comprising storing at least some information that correlates the remote non-central node with the at least one network address that is presently supported by the remote non-central node.

18. An apparatus comprising:
a first interface for operably coupling to a wireless access point;
a second interface for operably coupling to an extranet;
a first memory having locally-supported network addresses stored therein;
a second memory having non-locally supported network addresses stored therein.

19. The apparatus of claim 18 wherein the apparatus comprises, at least in part, at least one of:
a home agent;
a packet data serving node;
a gateway general packet radio service support node;
an authentication, authorization, and accounting server;
a foreign agent control node;
a serving general packet radio service support node.

20. The apparatus of claim 18 wherein the second interface comprises an Internet Protocol compatible interface and the extranet comprises an Internet.

21. The apparatus of claim 18 wherein the second memory further has stored therein information regarding at least one non-local node that does support at least one of the non-locally supported network addresses.

22. The apparatus of claim 18 wherein the apparatus has at least a first mode of operation and a second mode of operation, wherein the first mode of operation supports direct facilitation of an extranet communication by a wireless node that uses one of the locally supported network addresses.

23. The apparatus of claim 22 wherein the second mode of operation supports automatically forwarding a communication request from a wireless node that uses one of the non-locally supported network addresses to a non-local node that does support the non-locally supported network address.

24. The apparatus of claim 18 and further comprising means for determining when a communication request is sourced by a wireless node that uses a locally supported network address.

25. The apparatus of claim 24 and further comprising means for determining when a communication request is sourced by a wireless node that uses at least one of the non-locally supported network addresses.

26. The apparatus of claim 25 and further comprising means for automatically communicating information that at least corresponds to the communication request to a non-local node when the communication request is sourced by a wireless node that uses at least one of the non-locally supported network addresses.

27. The apparatus of claim 26 wherein the non-local node is also identified in the second memory.

28. The apparatus of claim 18 wherein the apparatus comprises an integral structure.

29. The apparatus of claim 18 wherein the apparatus comprises a distributed structure.

30. The apparatus of claim 18 wherein at least some of the locally-supported network addresses are presently assigned to corresponding wireless nodes and at least some of the locally-supported network addresses are presently unassigned to corresponding wireless nodes.

31. A method to facilitate Internet Protocol communications by wireless nodes while avoiding Internet Protocol address duplication, comprising: at a home agent:
providing access to locally supported Internet Protocol addresses;
providing access to non-locally supported Internet Protocol addresses and corresponding non-central remote nodes that do support such non-locally supported Internet Protocol addresses;
receiving an Internet Protocol communication request as corresponds to a wireless node;
when the Internet Protocol communication request corresponds to a wireless node using a locally supported Internet Protocol address, directly facilitating the communication request;
when the Internet Protocol communication request corresponds to a wireless node using a non-locally supported Internet protocol address, automatically providing information regarding the communication request to a corresponding one of the non-central remote nodes, such that the non-central remote node can directly facilitate the communication request.
